(19) United States
(12) Patent Application Publication
(10) Pub. No.: US 2012/0029803 A1
(43) Pub. Date: Feb. 2, 2012

(54) FUEL-CONSUMPTION PROJECTING APPARATUS, FUEL-CONSUMPTION PROJECTING METHOD, FUEL-CONSUMPTION PROJECTING PROGRAM, AND RECORDING MEDIUM

(75) Inventors: Mitsuo Yasushi, Sayama (JP); Masatoshi Yanagidaira, Funabashi (JP)

(73) Assignee: PIONEER CORPORATION, Kanagawa (JP)

(21) Appl. No.: 13/263,025

(22) PCT Filed: Apr. 7, 2009
(86) PCT No.: PCT/JP2009/057132

§ 371 Date: Oct. 5, 2011

(51) Int. Cl. G01F 9/02

(52) U.S. Cl. 701/123

(57) ABSTRACT

A fuel-consumption projecting apparatus estimates fuel consumption by a vehicle for a given interval. A projecting unit uses a first equation to project the fuel consumption before the vehicle begins travel along the given interval. An estimating unit uses a second equation that sets acceleration during travel as a variable, to estimate fuel consumption occurring during travel. A correcting unit corrects the first equation, based on the fuel consumption projected by the projecting unit and the fuel consumption estimated by the estimating unit.

### TECHNICAL FIELD

The present invention relates to a fuel-consumption projecting apparatus, a fuel-consumption projecting method, a fuel-consumption projecting program, and a recording medium that estimate vehicle fuel efficiency. However, use of the invention is not limited to the fuel-consumption projecting apparatus, fuel-consumption projecting method, fuel-consumption projecting program, and the recording medium above.

### BACKGROUND ART

Conventionally, various methods have been proposed to project fuel consumption of a vehicle in transit (see, for example, Patent document 1). Patent document 1 discloses technology that retrieves a route for which fuel consumption is low. The disclosed technology stores according to vehicle type, fuel consumption information corresponding to traveling speed, and uses link data and the fuel consumption information to calculate a route for which the least amount of fuel is consumed. Additionally, Patent document 1 discloses a method that correlates traveling speed and the fuel consumption information collected from a fuel consumption detector and that uses the correlated information in subsequent fuel-consumption projections.

FIG. 12 is a graph of vehicle speed and fuel consumption. In FIG. 12, the vertical axis indicates fuel consumption and the horizontal axis indicates traveling speed. The relation between traveling speed and fuel consumption is commonly known to be expressed by the equation below, for example.

fc=m1+m2·x2+m3·x3+m4·x

Here, fc represents fuel consumption per unit time; x represents average speed for a unit interval; and m1 to m4 are constants.
Patent Document 1: Japanese Patent Application Laid-Open Publication No. 2005-172582

### DISCLOSURE OF INVENTION

### Problem to be Solved by the Invention

However, the conventional technology above does not take vehicle acceleration into account when projecting fuel consumption, arising in a problem of low projection accuracy. The effect vehicle acceleration has on fuel consumption is not small. For example, if acceleration during travel is out of the ordinary, the projection accuracy of the conventional technology above becomes poor. The shape and slope of the traveled road, driving technique (abrupt acceleration, etc.) may also cause the margin of error to increase between the actual and the projected fuel consumption. Furthermore, since the frequency of acceleration is high on winding roads, when such roads are traveled, projection accuracy becomes poor.

### Means for Solving Problem

To solve the problems above and achieve an object, a fuel-consumption projecting apparatus according to claim 1 projects fuel consumption by a vehicle for a given interval. The fuel-consumption projecting apparatus includes a projecting unit that using a first equation, projects the fuel consumption before travel begins along the given interval; an estimating unit that using a second equation that sets vehicle acceleration occurring during travel as a variable, estimates the fuel consumption occurring during travel; a correcting unit that corrects the first equation, based on the fuel consumption projected by the projecting unit and the fuel consumption estimated by the estimating unit.

Further, a fuel-consumption projecting method according to claim 11 is a method of projecting fuel consumption by a vehicle for a given interval. The fuel-consumption projecting method includes projecting the fuel consumption before travel begins along the given interval, by using a first equation; estimating the fuel consumption occurring during travel, the fuel consumption being estimated by using a second equation that sets vehicle acceleration occurring during travel as a variable; and correcting the first equation, based on the fuel consumption projected at the projecting and the fuel consumption estimated at the estimating.

A fuel-consumption projecting program according to claim 12 causes a computer to execute the fuel-consumption projecting method according to claim 11.

Further, a recording medium according to claim 13 stores therein the fuel-consumption projecting program according to claim 12.

### BRIEF DESCRIPTION OF DRAWINGS

FIG. 1 is a block diagram of a functional configuration of a fuel-consumption projecting apparatus according to an embodiment;

FIG. 2 is a flowchart of a fuel-consumption projecting process of the fuel-consumption projecting apparatus;

FIG. 3 is a block diagram of a hardware configuration of a navigation apparatus;

FIG. 4 is a schematic of an example of a fuel consumption projecting process by the navigation apparatus;

FIG. 5 is a schematic of an example of the fuel consumption projecting process by the navigation apparatus;

FIG. 6 depicts a coefficient table retained by the navigation apparatus;

FIG. 7 is a graph of coefficient k₁ and displacement;

FIG. 8 is a graph of coefficient k₂ and vehicle weight;

FIG. 9 is a graph of coefficient k₃ and displacement;

FIG. 10 is a schematic of acceleration of a vehicle traveling a road that has a slope;

FIG. 11 is a flowchart of the fuel-consumption projecting process performed by the navigation apparatus 300; and

FIG. 12 is a graph of vehicle speed and fuel consumption.

### BEST MODE(S) FOR CARRYING OUT THE INVENTION

With reference to the accompanying drawings, preferred embodiments of a fuel-consumption projecting apparatus, a fuel-consumption projecting method, a fuel-consumption projecting program, and a recording medium according to the present invention will be described in detail.

### Embodiment

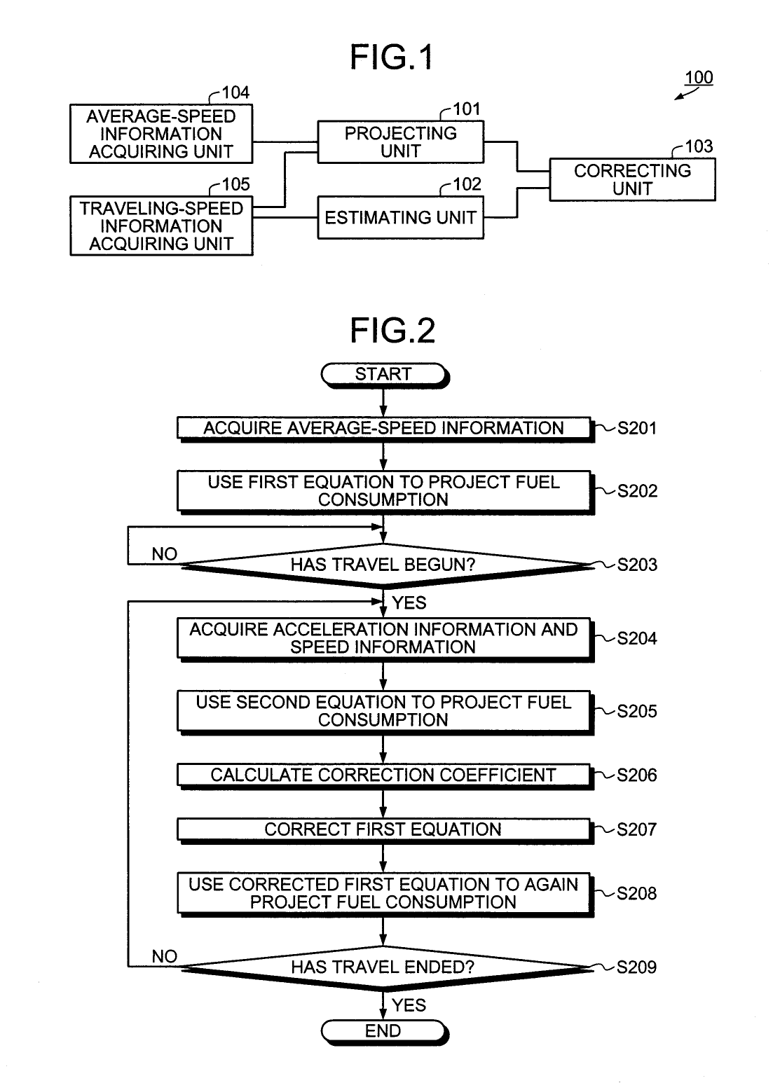

FIG. 1 is a block diagram of a functional configuration of a fuel-consumption projecting apparatus according to an embodiment. A fuel-consumption projecting apparatus 100 projects vehicle fuel consumption for a given interval and includes a projecting unit 101, an estimating unit 102, a correcting unit 103, an average-speed information acquiring unit 104, and a traveling-speed information acquiring unit 105. Here, a given interval is, for example, a route linking a user set starting point and destination. Hereinafter, the interval for which the fuel-consumption projecting apparatus 100 projects fuel consumption is referred to as the “projection-target interval”.

The projecting unit 101 uses a first equation and projects fuel consumption, before the vehicle begins to travel the projection-target interval. The first equation is function that sets vehicle speed as a variable and for example, is equation (1). Fuel consumption calculated using equation (1) indicates instantaneous fuel consumption. Consequently, the total amount of fuel consumed when the projection-target interval is traveled is obtained by the summation of equation (1).

fc₁(x)=h·(m₁+m₂·x²+m₃·x³+m₄·x) (1)

### Where,

fc₁: fuel consumption per unit time (cc/sec)

x:

$$speed ( \frac{km}{h } )$$

h: correction coefficient

m₁ to m₄: constants

To project fuel consumption, the projecting unit 101 substitutes into the first equation, average speed information (average speed information for each unit interval in the projection-target interval) acquired by the average-speed information acquiring unit 104 described hereinafter. Further, configuration may be such that to recalculate fuel consumption, the projecting unit 101 substitutes into the first equation, speed information that is acquired by the traveling-speed information acquiring unit 105 during travel along the projection-target interval.

The estimating unit 102 uses a second equation that regards vehicle acceleration during travel along the projection-target interval as a variable and estimates the amount of fuel consumed for travel along the projection-target interval. The second equation is a function that sets vehicle acceleration and speed as variables and is equation (2), for example. Fuel consumption calculated using equation (2) indicates instantaneous fuel consumption. Consequently, the total amount of fuel consumed when the projection-target interval is traveled is obtained by the summation of equation (2).

$$\begin{matrix}{fc}_{2} ( x ) = {k}_{1} + {k}_{2} \cdot x \cdot ( \frac{d x}{d t} + g \cdot sin θ ) + {k}_{3} \cdot G ( x ) \\ G ( x ) = {x}^{3} + {a}_{1} \cdot {x}^{2} + {a}_{2} \cdot x\end{matrix} \} \qquad ( 2 )$$

### Where,

fc₂(x): fuel consumption per unit time (cc/sec)

x: speed

$$( \frac{km}{h} )$$

$$\frac{d x}{d t} \text{:} acceleration ( \frac{km}{h \cdot s} )$$

g: gravitational acceleration

$$( = 35.3 ( \frac{km}{h \cdot s} ) )$$

θ: slope of traveled road (radian)

k₁: coefficient based on fuel consumption when vehicle is stopped with engine running

$$( \frac{cc}{s} )$$

k₂: coefficient based on fuel consumption during acceleration

$$( \frac{cc \cdot {h}^{2}}{{km}^{2}} )$$

k₃: coefficient based on drag and rolling resistance

$$( \frac{cc \cdot {h}^{3}}{{km}^{3} \cdot s} )$$

a₁=−100 (km/h)

a₂=6000 (km/h²)

In equation (2), time is indicated in units of hours (h) and seconds (s) because distance per hour (km/h) is adopted as the unit for speed and seconds (s) are adopted as the unit of time for estimating fuel consumption. Appropriate calculations are performed on the values if the units of time are to be made uniform.

The correcting unit 103 corrects the first equation, based on the fuel consumption projected by the projecting unit 101 and the fuel consumption estimated by the estimating unit 102. The correcting unit 103, for example, calculates a correction coefficient from the fuel consumption projected by the projecting unit 101 and the fuel consumption estimated by the estimating unit 102 and appends the calculated correction coefficient to the first equation to thereby correct the first equation. The correction coefficient is, for example, the ratio of the fuel consumption projected by the projecting unit 101 and the fuel consumption estimated by the estimating unit 102. In this case, a correction coefficient h is expressed by equation (3), where Σ indicates the summation of instantaneous fuel consumption of intervals traveled by the vehicle.

$$h = \frac{\sum {fc}_{2} ( x )}{\sum {fc}_{1} ( x )} \qquad ( 3 )$$

The correcting unit 103, for example, regards the ratio of the fuel consumption projected by the projecting unit 101 before travel along the projection-target interval begins and the fuel consumption estimated by the estimating unit 102 during travel along the projection-target interval as the correction coefficient. Further, for example, during travel along the projection-target interval, if the projecting unit 101 recalculates the fuel consumption by substituting into the first equation, speed information (speed information acquired by the traveling-speed information acquiring unit 105) for the vehicle in transit, configuration may be such that the correcting unit 103 regards the ratio of the recalculated fuel consumption and the fuel consumption estimated by the estimating unit 102 as the correction coefficient.

Further, configuration may be such that when, for example, during travel along the projection-target interval, the type of the road traveled by the vehicle does not change for a given distance or longer, or for a given period or longer, the correcting unit 103 corrects equation (1). When the road type changes, vehicle speed/acceleration may significantly change and if the acceleration information and speed information before the change is used, the accuracy of the fuel consumption estimate may drop. Further, configuration may be such that the correcting unit 103, for example, corrects the first equation at given periods during travel along the projection-target interval.

The average-speed information acquiring unit 104 acquires for each unit interval in the projection-target interval, average speed information. A unit interval, for example, is a link in map data. Further, average speed information is the distance of a unit interval divided by the average time required to traverse the unit interval. The average-speed information acquiring unit 104, for example, reads out average speed information included in map data to acquire the average speed information.

The traveling-speed information acquiring unit 105 acquires acceleration information and speed information for the vehicle in transit. The traveling-speed information acquiring unit 105, for example, acquires acceleration information and speed information output from an accelerometer and speedometer equipped on the vehicle. If an accelerometer and speedometer are equipped on the fuel-consumption projecting apparatus 100, the acceleration information and speed information from these sensors may be acquired. Further, configuration may be such that the traveling-speed information acquiring unit 105 itself can measure (or calculate) acceleration and speed.

FIG. 2 is a flowchart of a fuel-consumption projecting process of the fuel-consumption projecting apparatus. In the flowchart depicted in FIG. 2, in the fuel-consumption projecting apparatus 100, the average-speed information acquiring unit 104 acquires average speed information for the projection-target interval, before travel along the projection-target interval begins (step S201); and the projecting unit 101 uses the first equation to project fuel consumption for the projection-target interval (step S202).

The fuel-consumption projecting apparatus 100 remains in standby until the vehicle begins to travel (step S203: NO) and when the vehicle begins to travel (step S203: YES), the traveling-speed information acquiring unit 105 acquires acceleration information and speed information for the vehicle (step S204). Subsequently, in the fuel-consumption projecting apparatus 100, the estimating unit 102 uses the second equation to estimate fuel consumption of the vehicle in transit (step S205).

Further, in the fuel-consumption projecting apparatus 100, the correcting unit 103 calculates a correction coefficient (step S206) and corrects the first equation used by the projecting unit 101 to project fuel consumption (step S207). The correction coefficient calculated at step S206, for example, is the ratio of the fuel consumption projected by the projecting unit 101 before travel along the projection-target interval begins and the fuel consumption estimated by the estimating unit 102 during travel along the projection-target interval. Further, the correction coefficient, for example, may be the ratio of the fuel consumption recalculated by substituting into the first equation (1), actual speed information (the speed information acquired at step S204) for the vehicle in transit and the fuel consumption estimated by the estimating unit 102.

The projecting unit 101 uses the first equation corrected at step S207 and again projects fuel consumption (step S208). For example, the projecting unit 101 substitutes into the corrected first equation (1), average speed information for the remaining portion of the projection-target interval and thereby calculates fuel consumption for the remaining portion of the projection-target interval.

Until the vehicle completes travel along the projection-target interval (step S209: NO), the fuel-consumption projecting apparatus 100 returns to step S204 and continues the processes therefrom. When the vehicle completes travel along the projection-target interval (step S209: YES), the fuel-consumption projecting apparatus 100 ends the process according to the present flowchart.

As described, the fuel-consumption projecting apparatus 100 corrects the equation used in the projection of fuel consumption, by an estimated value of fuel consumption obtained using actual acceleration information and speed information for the vehicle in transit. Consequently, fuel consumption can be projected with consideration of vehicle acceleration, enabling accurate projection of fuel consumption even if acceleration changes greatly during travel along the road, such as along a road that has numerous curves, a steep slope, etc.

Further, after the vehicle begins travel, the fuel-consumption projecting apparatus 100 estimates fuel consumption using speed information and acceleration information for the vehicle, slope information for the road traveled by the vehicle, and equation (2) to estimate fuel consumption. Consequently, the fuel-consumption projecting apparatus 100 can reflect to the fuel consumption projection, changes in vehicle speed and acceleration, changes in potential energy according to the vehicle, etc., enabling more accurate projection of fuel consumption.

### Example

An example of the present invention will be described. Here, an application example of the present invention will be described where a navigation apparatus 300 equipped on a vehicle is applied as the fuel-consumption projecting apparatus 100.

### (Hardware Configuration of Navigation Apparatus 300)

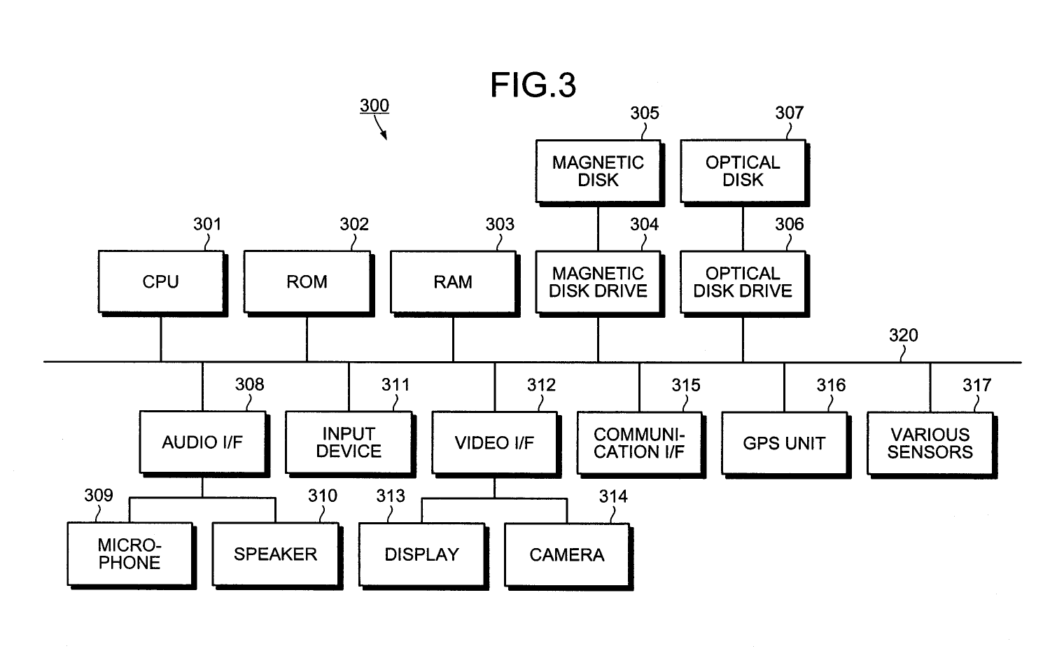

A hardware configuration of the navigation apparatus 300 will be described. FIG. 3 is a block diagram of a hardware configuration of the navigation apparatus. As depicted in FIG. 3, the navigation apparatus 300 includes a CPU 301, ROM 302, RAM 303, a magnetic disk drive 304, a magnetic disk 305, an optical disk drive 306, an optical disk 307, an audio I/F (interface) 308, a microphone 309, a speaker 310, an input device 311, a video I/F 312, a display 313, a camera 314, a communication I/F 315, a GPS unit 316, and various sensors 317, all components respectively connected through a bus 320.

The CPU 301 governs overall control of the navigation apparatus 300. The ROM 302 stores therein various programs such as a boot program, a route retrieving program, etc. The RAM 303 is used a work area of the CPU 301, i.e., the CPU 301 while using the RAM 303 as a work area, executes various programs stored in the ROM 302 to govern overall control of the navigation apparatus 300.

The magnetic disk drive 304 controls the reading and the writing of data with respect to the magnetic disk 305 under the control of the CPU 301. The magnetic disk 305 records data written thereto under the control of the magnetic disk drive 304. As the magnetic disk 305, for example, an HD (hard disk), FD (flexible disk), etc. may be used.

The optical disk drive 306 controls the reading and the writing of the data with respect to the optical disk 307, under the control of the CPU 301. The optical disk 307 is a removable recording medium from which data is read under the control of the optical disk drive 306. The optical disk 307 may be a writable recording medium. As the removal recording medium, a medium other than the optical disk 307 can be employed, such as an MO and a memory card.

Information recorded on the magnetic disk 305 and the optical disk 307 may be, for example, content data and map data. Content data, for example, is music data, still image data, moving picture data, etc. Map data includes background data indicative of terrestrial objects (features) such as buildings, rivers, and ground surfaces, and road-shape data indicative of the shapes of roads; the data being divided into data files according to region.

The audio I/F 308 is connected to the microphone 309 for audio input and the speaker 310 for audio output. Sound received by the microphone 309 is subjected to A/D conversion at the audio I/F 308. The speaker 310 outputs sound subjected to A/D conversion at the audio I/F 308.

The input device 311 may be, for example, a remote controller having keys used to input characters, numerical values, or various kinds of instructions, a keyboard, a mouse, or a touch panel. Further, the input device 311 may be implemented by any one, or more, of the remote controller, the keyboard, and the touch panel.

The video I/F 312 is connected to the display 313. The video I/F 312 is made up of, for example, a graphic controller that controls the display 313, a buffer memory such as VRAM (Video RAM) that temporarily stores immediately displayable image information, and a control IC that controls the display 313 based on image data output from the graphic controller.

The camera 317 captures images inside and outside the vehicle. The images may be still images or moving images. For example, images taken by the camera 317, capturing views and terrestrial objects outside the vehicle and the behavior of passengers inside the vehicle are stored through the video I/F 312 to a recording medium such as the magnetic disk 305 and the optical disk 307.

The display 313 displays icons, a cursor, menus, windows, or various data such as text and images. Map information may be drawn on the display 313 two-dimensionally or 3-dimensionally. A mark representing the current position of the vehicle on which the navigation apparatus 300 is equipped may be displayed superimposed on the map information displayed on the display 313. The current position of the mobile object is calculated by the CPU 301. A TFT liquid crystal display, an organic electroluminescence display, and the like may be employed as the display 313.

The communication I/F 315 wirelessly connected to a network and functions as an interface between the navigation apparatus 300 and the CPU 301. Further, the communication I/F 315 communicates data with nearby electronic devices, by short distance communication such as infrared communication, Bluetooth (registered trademark), etc. The communication I/F 315 further receives television and radio broadcasts. Broadcasts received by the communication I/f 315 are output, via the audio I/F 308 and the video I/F 312, as audio information/video information by the speaker 310 and the display 313.

The GPS unit 316 receives signals from GPS satellites and outputs information indicating the position of the vehicle. The information output by the GPS unit 316 is used together with values output from the various sensors 317, described hereinafter, in the calculation of the current position of the vehicle, by the CPU 301. Information indicative of current position includes, for example, information indicating one point on map information, such as latitude, longitude, altitude, etc.

The various sensors 317 include a vehicle speed sensor, an acceleration sensor, and an angular speed sensor that respectively output information used to determine the position and behavior of the vehicle. Values output from the various sensors 317 are used by the CPU 301 to compute the current position and compute changes in speed, direction, etc.

Functions of the projecting unit 101, the estimating unit 102, the correcting unit 103, the average-speed information acquiring unit 104, and the traveling-speed information acquiring unit 105 of the fuel-consumption projecting apparatus 100 depicted in FIG. 1 are implemented by using programs and data recorded on the ROM 302, the RAM 303, the magnetic disk 305, the optical disk 307 of the navigation apparatus 300 depicted in FIG. 3, to execute a given program on the CPU 301 and control the respective components of the navigation apparatus 300.

### (Overview of Fuel Consumption Estimation by Navigation Apparatus 300)

The fuel-consumption projecting process performed by the navigation apparatus 300 will be described. In the description, “the amount of fuel consumed” and “fuel consumption” have the same meaning. Although the navigation apparatus 300 has a function of retrieving a route linking a starting point and a destination set by a designated user, the navigation apparatus 300 according to the present embodiment additionally has a function of projecting the amount of fuel consumed for travel along the retrieved route. For example, before the vehicle begins to travel along the route, the navigation apparatus 300 uses the first equation to project the amount of fuel consumed for travel along the route and after travel along the route has begun, the navigation apparatus 300 uses the second equation, which sets actual speed information and acceleration information of the vehicle as variables, to estimate the actual amount of fuel consumed for travel along the route. Subsequently, the navigation apparatus 300 uses the estimated fuel consumption to correct the fuel consumption projecting equation (first equation).

### [Fuel Consumption Projection Before Travel Begins]

Before the vehicle begins to travel along a route, the navigation apparatus 300 projects the amount of fuel consumed for travel along the route. For example, the navigation apparatus 300 uses equation (1) below to calculate fuel consumption. Equation (1) is called “the fuel consumption projecting equation” and the fuel consumption calculated using equation (1) is called “projected fuel consumption”. In equation (1), h represents a correction coefficient and before travel begins, is assumed as h=1, for example.

fc₁(x)=h·(m₁+m₂·x²+m₃·x³+m₄·x) (1)

In equation (1), although speed x is an independent variable, since the actual traveling speed is unknown before travel begins, the speed x is assumed as the average traveling speed along the route. The average traveling speed, for example, is calculated by dividing the distance of the route, by the average time required to travel the route. For the average time required to traverse a given interval, for example, average-required-time data recorded in the navigation apparatus 300 as a database is used. The route may be divided into a given number of intervals (e.g., a node, which is a unit interval) and the average traveling speed may be calculated for each interval.

[Fuel Consumption Estimation after Travel Begins]

When the vehicle begins travel, the navigation apparatus 300 acquires acceleration information and speed information for the vehicle in real-time and calculates fuel consumption that reflects the actual traveling state of the vehicle. For example, the navigation apparatus 300 uses equation (2) below to calculate fuel consumption that takes acceleration of the vehicle into consideration. Equation (2) is called “fuel consumption estimating equation” and fuel consumption calculated using equation (2) is called “estimated fuel consumption”. The fuel consumption estimating equation is not limited to equation (2) and may be that which enables acquisition of vehicle acceleration information and speed information in real-time and estimation of fuel consumption.

$$\begin{matrix}{fc}_{2} ( x ) = {k}_{1} + {k}_{2} \cdot x \cdot ( \frac{d x}{d t} + g \cdot sin θ ) + {k}_{3} \cdot G ( x ) \\ G ( x ) = {x}^{3} + {a}_{1} \cdot {x}^{2} + {a}_{2} \cdot x\end{matrix} \} \qquad ( 2 )$$

### Where,

fc₂(x): fuel consumption per unit time (cc/sec)

x: speed

$$( \frac{km}{h} )$$

$$\frac{d x}{d t} \text{:} acceleration ( \frac{km}{h \cdot s} )$$

g: gravitational acceleration

$$( = 35.3 ( \frac{km}{h \cdot s} ) )$$

θ: slope of traveled road (radian)

k₁: coefficient based on fuel consumption when vehicle is stopped with engine running

$$( \frac{cc}{s} )$$

k₂: coefficient based on fuel consumption during acceleration

$$( \frac{cc \cdot {h}^{2}}{{km}^{2}} )$$

k₃: coefficient based on drag and rolling resistance

$$( \frac{cc \cdot {h}^{3}}{{km}^{3} \cdot s} )$$

a₁=−100 (km/h)

a₂=6000 (km/h²)

In equation (2), time is indicated in units of hours (h) and seconds (s) because distance per hour (km/h) is adopted as the unit for speed and seconds (s) are adopted as the unit of time for estimating fuel consumption. Appropriate calculations are performed on the values if the units of time are to be made uniform.

Further, from the ratio of the projected fuel consumption calculated using equation (1) and the estimated fuel consumption calculated using equation (2), the navigation apparatus 300 calculates the correction coefficient h expressed by equation (3) below.

$$h = \frac{\sum {fc}_{2} ( x )}{\sum {fc}_{1} ( x )} \qquad ( 3 )$$

The navigation apparatus 300 substitutes the calculated correction coefficient h into equation (1) to correct the fuel consumption projecting equation and uses the corrected fuel consumption projecting equation to again project fuel consumption for the remaining portion of the route (correction of fuel consumption). Consequently, fuel consumption reflecting the actual acceleration and speed during travel can be projected. The effect vehicle acceleration has on fuel consumption is not small. Like the navigation apparatus 300, actual acceleration information is used to correct fuel consumption, whereby more accurate fuel consumption can be projected.

Correction of the fuel consumption projecting equation is performed periodically, at a given timing, e.g., every 10 minutes. Further, for example, if the type of the road traveled by the vehicle does not change for a given period or longer, or for a given distance or longer, correction of the fuel consumption projecting equation may be performed. When the road type changes, vehicle speed/acceleration may significantly change and if the acceleration information and speed information before the change is used, the accuracy of the fuel consumption estimate may drop.

### [Detailed Example of Fuel Consumption Projecting Process]

### <First Method>

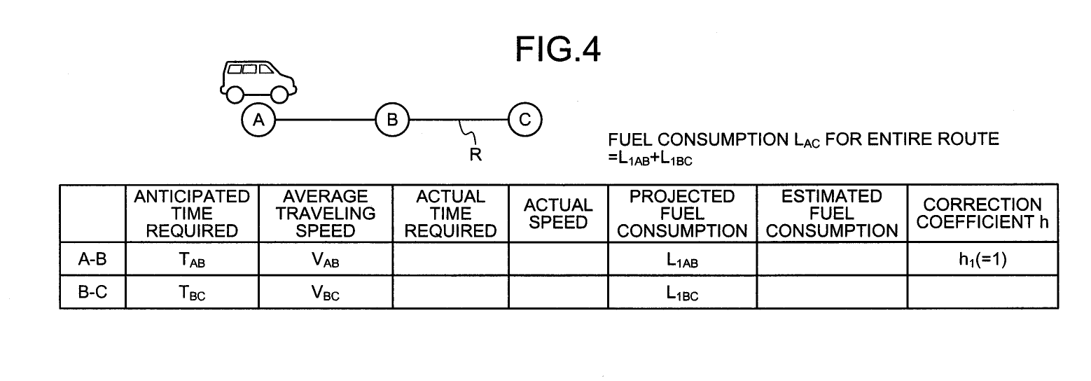

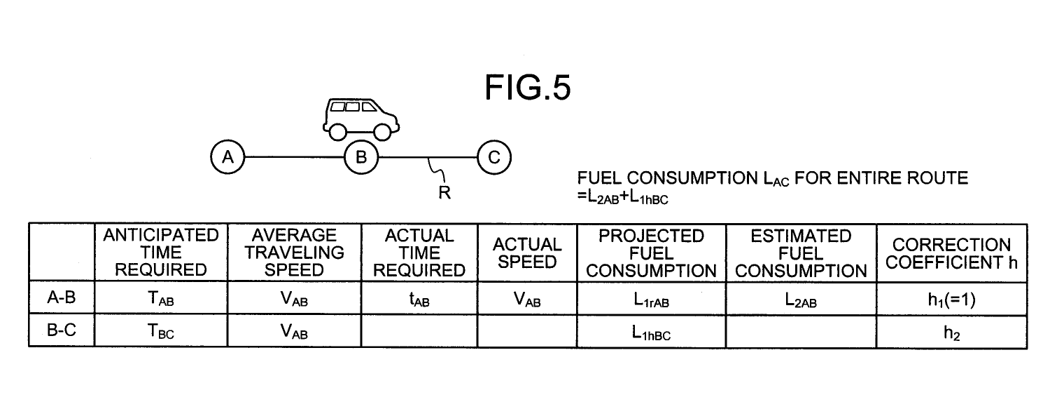

FIGS. 4 and 5 are schematics of the fuel consumption projecting process by the navigation apparatus. For example, if a route R, which starts at a starting point A passes through a point B to a destination C, is traveled, the navigation apparatus 300 uses equation (1) to calculate the projected fuel consumption L_{1AC} before travel along the route R begins, as depicted in FIG. 4.

For example, the navigation apparatus 300 uses the projected required time T_{AB} and the average traveling speed V_{AB} for the interval between A and B to calculate the projected fuel consumption L_{1AB} between A and B. L_{1AB} is expressed by equation (4) below using equation (1). Further, the navigation apparatus 300 uses the projected required time T_{BC} and the average traveling speed V_{BC} for the interval between B and C to calculate the projected fuel consumption L_{1BC} between B and C. L_{1BC} is expressed by equation (5) below using equation (1). Fuel consumption L_{AC} for the route R is expressed by equation (6) using L_{1AB} and L_{1BC}. In equations (4) and (5), h₁ represents the correction coefficient for the starting point A and is set as h₁=1.

L_{1AB}=h₁·T_{AB}·fc₁(V_{AB}) (4)

L_{1BC}=h₁·T_{BC}·fc₁(V_{BC}) (5)

L_{AC}=L_{1AB}+L_{1BC} (6)

As depicted in FIG. 5, when travel begins, the navigation apparatus 300 acquires acceleration information and speed information indicative of the actual acceleration and speed of the vehicle and uses equation (2) to calculate the estimated fuel consumption. The estimated fuel consumption is the instantaneous fuel consumption and therefore, by a summation of the instantaneous fuel consumption between A and B, the fuel consumption between A and B can be calculated. For example, the estimated fuel consumption L_{2AB} between A and B is expressed by equation (7) below. In equation (7), v_{AB} represents information indicative of the actual speed and Σ indicates summation of the value of fc₂ for the interval between A and B.

L_{2AB}=Σfc₂(v_{AB}) (7)

Further, the navigation apparatus 300 uses equation (1) and calculates the projected fuel consumption based on information indicative of the actual speed. For example, when point B is reached, the navigation apparatus 300 uses the actual required time t_{AB} for travel between A and B and the average value v_{AB}_{_{—}}ₐᵥ of the actual speed v_{AB} between A and B (average speed between A and B) to calculate the projected fuel consumption L_{1rAB} expressed by equation (8) below.

L_{1rAB}=h₁·t_{AB}·fc₁(v_{AB}_{_{—}}ₐᵥ) (8)

As indicated by equation (9), the ratio between the projected fuel consumption and the estimated fuel consumption respectively calculated from information indicative of the actual speed is set as the correction coefficient h₂, whereby, the relation between the fuel consumption calculated from the average speed and the fuel consumption calculated taking into account the actual speed and acceleration, can be appropriately corrected.

h₂=L_{1rAB}/L_{2AB} (9)

The navigation apparatus 300 applies the correction coefficient h₂ calculated as described to equation (1) and again projects the amount of fuel consumed between B and C (projected fuel consumption). The projected fuel consumption L_{1hBC} again projected for the interval between B and C is expressed by equation (10). Further, for the fuel consumption between A and B, the value (L_{2AB}) of equation (7) is used, whereby the newly estimated fuel consumption L_{AC} for the route R is expressed by equation (11) below.

L_{1hBC}=h₂·T_{BC}·fc₁(V_{BC}) (10)

L_{AC}=L_{2AB}+L_{1hBC}=Σfc₂(v_{AB})+h₂·T_{BC}·fc₁(V_{BC}) (11)

### <Second Method>

Although, in the first method above, the navigation apparatus 300 uses information indicative of the actual speed after travel begins, to project the re-projected fuel consumption and calculate the correction coefficient, configuration may be such that the projected fuel consumption projected before travel begins is used as is to calculate the correction coefficient. In other words, the ratio of the estimated fuel consumption L_{2AB} between A and B (equation (7)) calculated at point B and the projected fuel consumption L_{1AB} between A and B calculated at point A (equation (4)) before travel, is used as the correction coefficient. In this case, the correction coefficient h₃ is expressed by equation (12) below.

h₃=L_{1AB}/L_{2AB} (12)

The first method is meaningful if there are numerous curves along the road between A and C. Along a road having numerous curves, even if the traveling speed does not vary, acceleration and deceleration occurs frequently and the magnitude thereof is large. Consequently, the fuel consumption calculated by equation (2) increases. In this case, correction that takes the effects of curves in the road into account, can be performed by substituting into equation (1), speed information indicative of the actual speed, again projecting the fuel consumption and calculating the correction coefficient.

Meanwhile, the second method is meaningful if congestion occurs frequently along the road between A and C. Along a congested road, the traveling speed of the vehicle becomes slow. Consequently, the fuel consumption calculated by equation (2) becomes small. However, travel at a slow speed consequent to congestion and simply traveling at a slow speed affect fuel consumption differently. Consequently, by the second method, correction that takes the effects of congestion into account, can be performed by using the average speed information and the projected fuel consumption as is.

Although adoption of either the first method or the second method is arbitrary, configuration may be such that, for example, when a road is retrieved, link-shape data concerning the road is referred to and if curvature is a given rate or more, the first method is adopted. Further, for example, configuration may be such that congestion information concerning the road is referred to and for an interval where congestion occurs, the second method is adopted. Configuration may be such that along the same route, the first method and the second method are switched between according to interval. Further, configuration may be such that even if the first method and the second method are adopted, for example, during travel along the projection-target interval, if the type of the road being traveled by the vehicle does not change, equation (1) is corrected.

### (Concerning Second Fuel Consumption Estimating Equation)

Equation (2), which is a second fuel consumption estimating equation, will be described in detail. Equation (2) is an equation that can stably calculate highly accurate fuel consumption by using information related to vehicle idling, information related to vehicle acceleration, and resistance occurring when the vehicle travels alone as variables. Further details are described hereinafter.

[Concerning Coefficients k₁ to k₃]

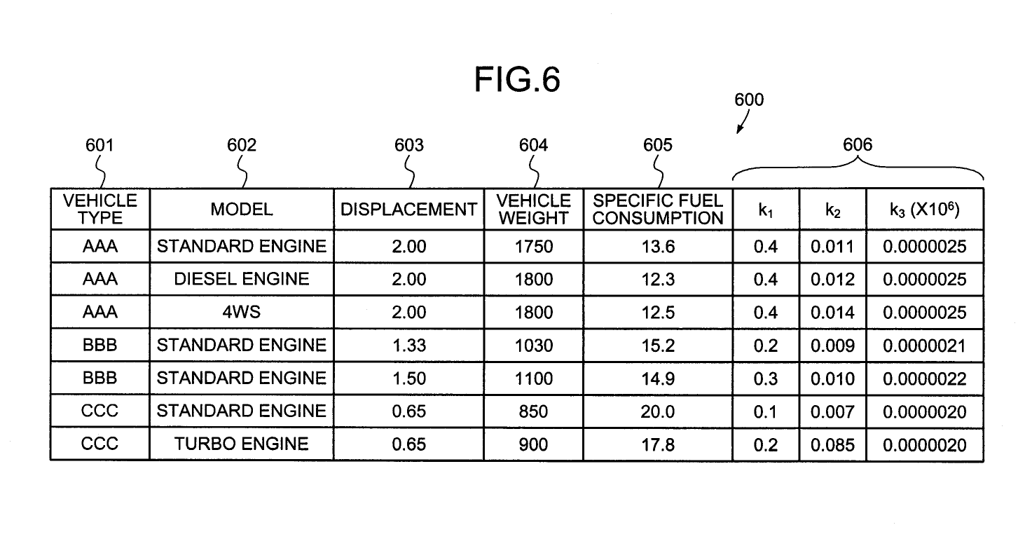

Coefficients k₁ to k₃ of equation (2) are described. FIG. 6 depicts a coefficient table retained by the navigation apparatus. In a coefficient table 600 depicted in FIG. 6, vehicle type 601 identifying the type of vehicle and model information 602 for each vehicle type are recorded, where coefficients (k₁ to k₃) 606 respectively corresponding thereto are further recorded. Displacement 603, vehicle weight 604, and specific fuel consumption 605 are further correlated with the vehicle type 601 and the model information 602, respectively.

Coefficients k₁ to k₃ vary according to vehicle type and model. The navigation apparatus 300 reads from the coefficient table 600, the coefficients k₁ to k₃ that correspond to the vehicle on which the navigation apparatus 300 is equipped. For example, if the navigation apparatus 300 can identify the vehicle type and model of the vehicle on which the navigation apparatus 300 is equipped, the navigation apparatus 300 selects the corresponding vehicle type 601 and model information 602, and reads out the coefficients correlated thereto.

If the navigation apparatus 300 cannot identify the vehicle type and model, but can identify the displacement and/or vehicle weight, the navigation apparatus 300 selects the corresponding displacement 603 and vehicle weight 604, and reads out the coefficients correlated thereto. Further, if the navigation apparatus 300 can identify the specific fuel consumption for the vehicle, the navigation apparatus 300 selects the corresponding specific fuel consumption 605, and reads out the coefficients correlated thereto.

Although an example has been given in which if the vehicle type and model cannot be identified, the coefficients are read out using the displacement and/or an approximate fuel consumption, configuration is not limited hereto. For example, even if the vehicle type and model can be identified, configuration may be such that data for naturally aspirated gasoline, diesel engine, turbo engine, etc. and information related to approximate fuel consumption, vehicle weight, displacement, etc. are used and the coefficients corresponding to a similar vehicle type and/or model are read out.

Next, the meaning of the respective coefficients k₁ to k₃ will be described. k₁ is a coefficient that indicates fuel consumption during idling (when the vehicle is not in motion). k₂ is a coefficient that indicates fuel consumption during acceleration. k₃ is a coefficient that is based on resistance occurring when the vehicle is in motion. The resistance that occurs when the vehicle is in motion includes drag and rolling resistance. Rolling resistance includes resistance that occurs accompanying rotation of the tires and rotation inside the engine.

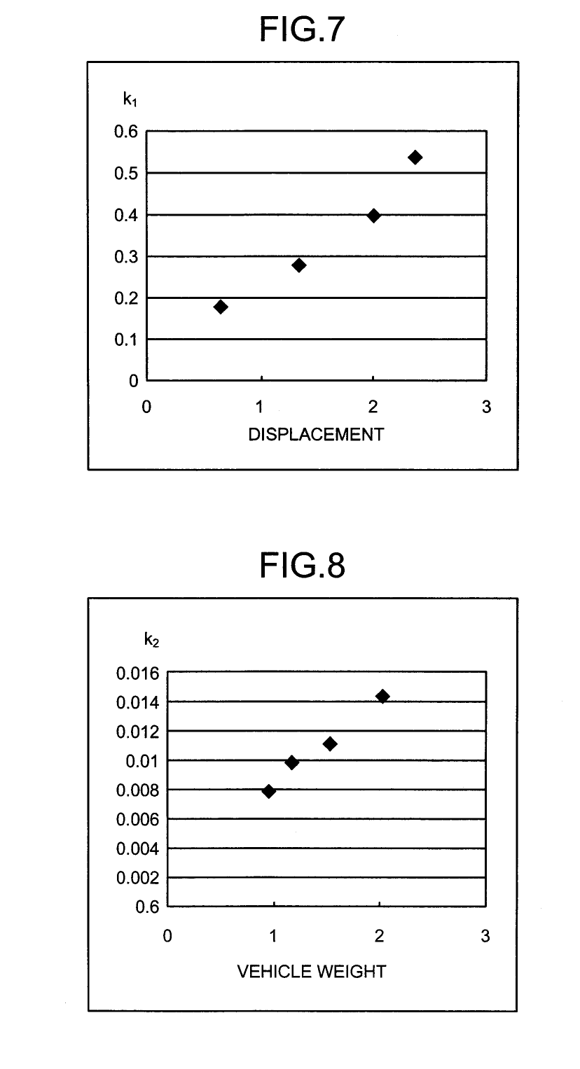

FIG. 7 is a graph of coefficient k₁ and displacement. The vertical axis indicates the value of coefficient k₁ and the horizontal axis indicates displacement. As depicted in FIG. 7, the coefficient k₁ and displacement are positively correlated. In other words, typically, the greater the displacement of the vehicle, the greater the fuel consumption is during idling and thus, the coefficient k₁ is a coefficient reflecting fuel consumption during idling.

FIG. 8 is a graph of the coefficient k₂ and vehicle weight. The vertical axis indicates the value of coefficient k₂ and the horizontal axis indicates vehicle weight. As depicted in FIG. 8, the coefficient k₂ and vehicle weight are positively correlated. In other words, typically, the greater the vehicle weight, the greater the fuel consumption is during acceleration and thus, the coefficient k₂ is a coefficient reflecting fuel consumption during acceleration.

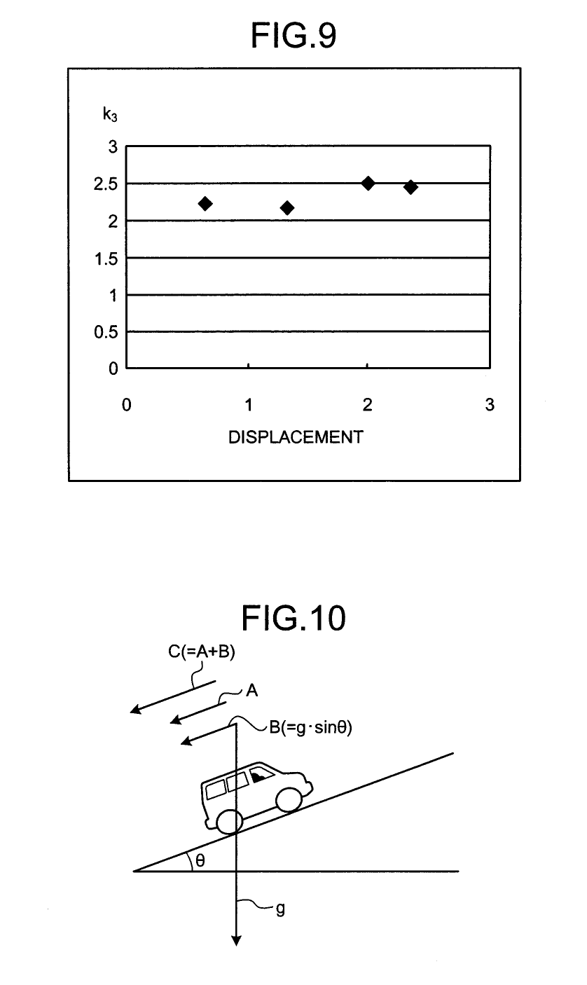

FIG. 9 is a graph of coefficient k₃ and displacement. The vertical axis indicates the value of coefficient k₃ and the horizontal axis indicates displacement. As depicted in FIG. 9, no correlation can be seen between the coefficient k₃ and displacement. This phenomenon is consequent to the coefficient k₃ being a coefficient based on resistance that occurs when the vehicle is in motion and therefore, coefficient k3 has a stronger correlation with vehicle shape than with displacement.

[Method for Databasing Coefficients k₁ to k₃]

The databasing of the values of the coefficients k₁ to k₃ will be described. A coefficient table (coefficient database) such as that depicted in FIG. 6 is built by the following procedure, for example.

### <First Procedure>

Actual traveling data for a representative vehicle type is measured and substituted into equation (α) below. Multi-regression analysis of equation (α) into which the actual traveling data has been substituted derives coefficients k₁, k₂, k₃, k₄, and k₅. Here, k₁ is a coefficient based on the fuel consumption during idling; k₂ a coefficient based on the fuel consumption during acceleration; k₃ a coefficient based on drag and rolling resistance; and k₄ and k₅ are coefficients for engine torque characteristics and transmission efficiency. Further, in equation (α), fc represents fuel consumption (cc/sec), x represents speed (km/h), dx/dt+g·sin θ represents resultant acceleration (vehicle acceleration and gravitational acceleration).

fc(x)=k₁+k₂·(dx/dt+g·sin θ)·x+k₃·x³+k₄·x²+k₅·x (α)

### <Second Procedure>

Among k₁ to k₅ obtained from the first procedure, k₃ to k₅ are used to derive a₁ and a2 in equation (2). a₁ and a2 are, for the most part, values common to all vehicle types and therefore, by setting these values as constants, the number of parameters can be reduced, e.g., a₁=k₄/k₃, a2=k₅/k₃.

### <Third Procedure>

For the coefficients k₁ to k₃ for vehicle types that are not typical equation (β) below is used and multi-regression analysis of the actual traveling data is performed. In equation (β), the parameters have been narrowed to three and the coefficients k₁ to k₃ obtained for each vehicle type, displacement, engine model, etc. are entered into a database.

fc(x)=k₁+k₂·(dx/dt+g·sin θ)·x+k₃·(x³+a₁·x²+a2·x) (β)

### [Concerning Road Slope θ]

Next, the road slope θ, which is the second term on the right of equation (2) will be discussed. FIG. 10 is a schematic of acceleration of a vehicle traveling a road that has a slope. As depicted in FIG. 10, for a vehicle to travel on a hill having a slope of θ, acceleration (dx/dt)A according to the vehicle motion and the traveling direction component (g·sin θ)B of gravitational acceleration g are needed. The second term on the right of equation (2) represents the resultant acceleration C of the acceleration A according to vehicle motion and the traveling direction component B of gravitational acceleration g.

If consideration is not given to the road slope θ when fuel consumption is estimated, the margin of error would be small for an area where the road slope θ is small, however, for an area where the road slope θ is large, the margin of error would be large. Consequently, the navigation apparatus 300 estimates fuel consumption with the consideration of road slope.

The slope of the road traveled by the vehicle, for example, can be known using an inclinometer equipped on the navigation apparatus 300. If an inclinometer is not equipped on the navigation apparatus 300, for example, slope information for roads included in map data can be used.

If slope information is not included in the map data, altitude data in the map data can be used or if the navigation apparatus is capable of three-dimensional positioning, altitude information of the positioning results can be used to estimate fuel consumption for sloped interval. For example, an approximation equation such as equation (13) below is used to estimate fuel consumption (sloped-interval fuel consumption) for a sloped interval.

sloped-interval fuel consumption=fuel consumption for interval constantly of 0+k₂·g·(altitude at end of interval-altitude at start of interval) (13)

The first term on the right of equation (2) “fuel consumption (for interval constantly of 0)” is a value that is the summation of the instantaneous fuel consumption for a given interval (the value of equation (2)). The second term on the right (altitude at end of interval-altitude at start of interval) represents variations in potential energy. Fuel consumption approximation for a sloped interval by equation (14) is demonstrated as follows.

interval fuel consumption=Σfc·ΔT

=Σ{k₁+k₂·x·(dx/dt+g·sin θ)+k₃·G(x)}ΔT

=k₁·ΣΔT+k₂·Σx(dx/dt+g·sin θ)ΔT+k₃·ΣG(x)ΔT (14)

Taking a closer look at the second term in equation (14),

ΣV(dx/dt+g·sin θ)ΔT=Σx·dx/dt·ΔT+g·Σ(x·sin θ)ΔT (15)

can be deduced, where the second term on the right in equation (15) “Σ(x·sin θ)ΔT” is displacement in the direction of altitude in the interval. The first term on the right in equation (15) is fuel consumption with respect to acceleration energy when the slope is taken as constantly 0 and therefore, integration with other parameters unrelated to slope, enables “interval fuel estimation calculated with a slope of constantly 0”. Consequently, even if no inclinometer is provided, if the latitude and longitude of the starting point and of the ending point of the interval are obtained, fuel consumption estimated with consideration of road slope becomes possible by referring to altitude data. Alternatively, if the navigation apparatus is capable of three-dimensional positioning, altitude information for the starting point and the ending point of the interval is referred to, whereby fuel consumption can be estimated with consideration of road slope.

### [Effect of Fuel Cuts]

In equation (2), if any of the conditions below are met consequent to the effects of fuel cuts, the value of fc is taken to be as follows.

fc=k₁, if fc₂<k₁ [1]

$$fc = {k}_{1} , if x \cdot \frac{d x}{d t} < - 50 \qquad [ 2 ]$$

$${fc}_{2} = 0 , if x > 20 and \frac{d x}{d t} < 0 \qquad [ 3 ]$$

Here, conditional expression [1] above is a prescribed condition based on the notion that the fuel consumption to be projected does not take on a positive value less than the fuel consumption during idling or a negative value. Therefore, for example, if the fuel consumption to be projected takes on a positive value less than k₁ or a negative value, according to conditional expression [1], the fuel consumption to be projected takes on the value of k₁. Conditional expressions [2] and [3] above are prescribed conditions related to fuel consumption during vehicle deceleration. According to vehicle type, when the vehicle decelerates without manipulation of the accelerator, there are occasions when fuel is not sent to the engine and if the actual fuel consumption and the projected fuel consumption differ, there are occasions when use of this condition for correction is meaningful. The values of fc in conditional expressions [1] to [3] above are merely examples and are appropriately adjusted according to vehicle type.

In this case, fc is not included in conditional expressions [2] and [3]. For example, if a given determination is to be made without obtaining the value of fc, these conditional expressions are particularly meaningful. For example, if the estimated fuel consumption is transmitted to a server, and statistical processing thereof is to be performed, the values of the conditional expressions k₁ to k₃ are separated from other values and processed. Thereafter, when the values of conditional expressions k₁ to k₃ are updated, the amount of calculations to be performed can be greatly reduced and as can recalculation of the conditional expressions.

### (Fuel-Consumption Projecting Process Performed by Navigation Apparatus 300)

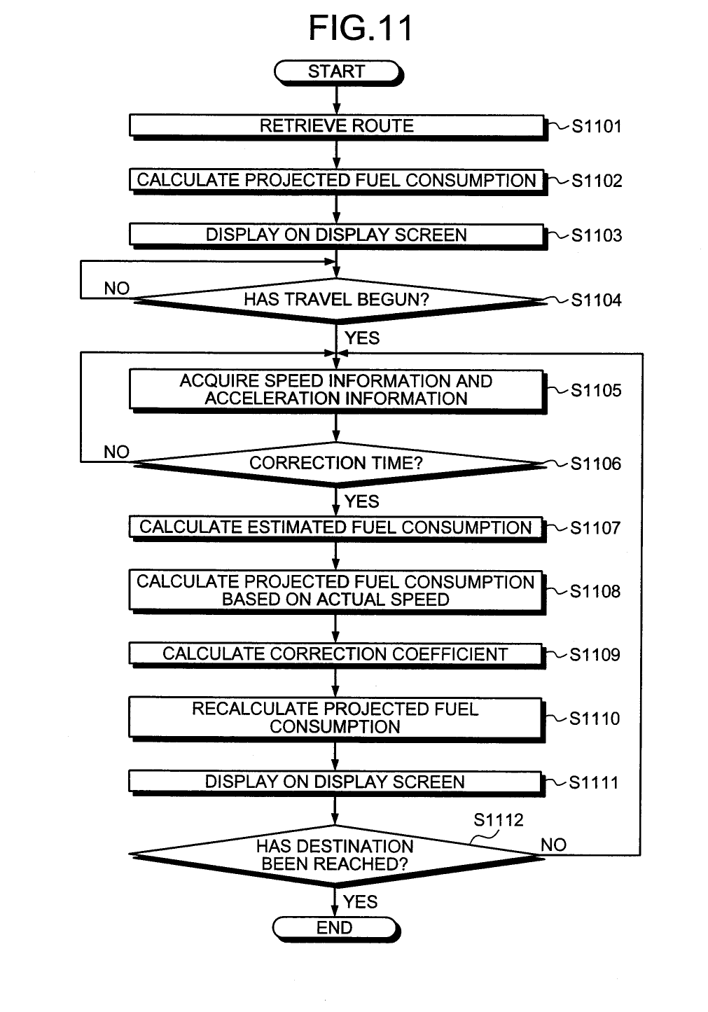

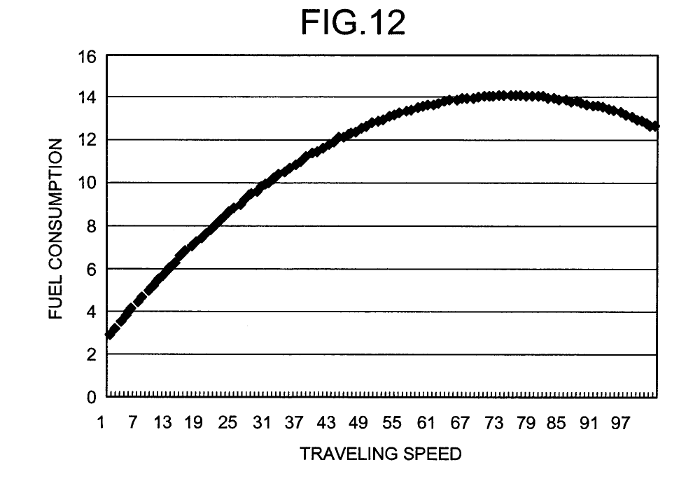

Next, the fuel-consumption projecting process performed by the navigation apparatus 300 will be described. FIG. 11 is a flowchart of the fuel-consumption projecting process performed by the navigation apparatus 300. FIG. 11 depicts the first method (refer to FIGS. 4 and 5) in the fuel consumption projecting process.

In the flowchart depicted in FIG. 11, the navigation apparatus 300 retrieves a route to the destination designated by the user (step S1101). Upon retrieving a route, the navigation apparatus 300 uses the average traveling speed for the route and equation (1) to calculate fuel consumption (projected fuel consumption) for the entire route (step S1102), and displays the projected fuel consumption on the display 313 (step S1103).

The navigation apparatus 300 remains in standby until the vehicle begins to travel (step S1104: NO). When the vehicle begins to travel (step S1104: YES), the navigation apparatus 300 acquires speed information and acceleration information for the vehicle (step S1105). Until the time for correction arrives (step S1106: NO), the navigation apparatus 300 returns to step S1105 and continues to acquire the speed information and acceleration information.

When the time for correction arrives (step S1106: YES), the navigation apparatus 300 uses the speed information and acceleration information acquired at step S1105 and equation (2) to calculate the estimated fuel consumption (the amount of fuel consumed thus far traveling along the route) (step S1107). Further, the navigation apparatus 300 uses the speed information acquired at step S1105 and calculates by equation (1), the projected fuel consumption based on the actual speed (step S1108). The navigation apparatus 300 calculates the correction coefficient from the estimated fuel consumption calculated at step S1107 and the projected fuel consumption that is based on the actual speed and calculated at step S1108 (step S1109).

The navigation apparatus 300 uses equation (1) to which the correction coefficient has been applied, to recalculate the projected fuel consumption for the remaining portion of the route (step S1110). The navigation apparatus 300 sums the estimated fuel consumption (the amount of fuel consumed thus far to travel along the route) calculated at step S1107 and the fuel consumption calculated, at step S1110, for the remaining portion of the route, and displays, on the display 313, the sum as fuel consumption for the entire route (step S1111). Rather than display as fuel consumption for the entire route, the amount of fuel consumed thus far and the amount of fuel to be consumed for the remaining portion of the route may be displayed separately, or any one of the amounts may be displayed alone.

Until the vehicle reaches the destination (step S1112: NO), the navigation apparatus 300 returns to step S1105 and repeats the steps therefrom. When the vehicle reaches the destination (step S1112: YES), the process according to the flowchart ends. In the flowchart, although the estimated fuel consumption is calculated at the time for correction, configuration may be such that the estimated fuel consumption is calculated as necessary during travel.

In the fuel consumption projecting process, in the case of the second method, without performing the process (calculation of the projected fuel consumption that is based on the actual speed) at step S1108, the correction coefficient may be calculated using the projected fuel consumption calculated at step S1102.

As described, the navigation apparatus 300 uses acceleration information corresponding to actual travel to correct an equation (equation (1)) used for projecting fuel consumption before travel begins. Consequently, fuel consumption can be calculated, taking vehicle acceleration into consideration. For example, even if the vehicle travels a road along which acceleration changes drastically, such as a road having a lot of curves or a steep slope, fuel consumption can be estimated with favorable accuracy.

Further, after travel begins, the fuel-consumption projecting apparatus 100 estimates fuel consumption by equation (2), which uses speed information and acceleration information for the vehicle and slope information for the traveled road. Consequently, the navigation apparatus 300 can reflect to the fuel consumption estimate, changes in vehicle traveling speed and acceleration, as well as changes in potential energy according to the vehicle, etc., enabling more accurate estimation of fuel consumption.

The fuel projecting method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the recording medium, and executed by the computer. The program may be a transmission medium that can be distributed through a network such as the Internet.

### EXPLANATIONS OF LETTERS OR NUMERALS

100 fuel-consumption projecting apparatus
101 projecting unit
102 estimating unit
103 correcting unit
104 average-speed information acquiring unit
105 traveling-speed information acquiring unit

1-13. (canceled)

14. A fuel-consumption projecting apparatus that projects fuel consumption by a vehicle for a given interval, the fuel-consumption projecting apparatus comprising:
a projecting unit that using a first equation, projects the fuel consumption before travel begins along the given interval;
an estimating unit that using a second equation that sets vehicle acceleration occurring during travel as a variable, estimates the fuel consumption occurring during travel;
a correcting unit that corrects the first equation, based on the fuel consumption projected by the projecting unit and the fuel consumption estimated by the estimating unit.

15. The fuel-consumption projecting apparatus according to claim 14, wherein
the first equation is a function that set vehicle speed as a variable, and
the second equation is a function that sets the vehicle acceleration and the vehicle speed as variables.

16. The fuel-consumption projecting apparatus according to claim 15, further comprising:
an average-speed information acquiring unit that acquires for each unit interval in the given interval, preliminarily stored average speed information; and
a traveling-speed information acquiring unit that acquires acceleration information and speed information for the vehicle in transit, wherein
the projecting unit uses the average speed information acquired by the average-speed information acquiring unit to project the fuel consumption before travel along the given interval begins, and
the estimating unit uses the acceleration information and the speed information acquired by the traveling-speed information acquiring unit to estimate the fuel consumption.

17. The fuel-consumption projecting apparatus according to claim 14, wherein the correcting unit calculates a correction coefficient from the fuel consumption projected by the projecting unit and the fuel consumption estimated by the estimating unit, and appends the correction coefficient to the first equation to correct the first equation.

18. The fuel-consumption projecting apparatus according to claim 17, wherein the correction coefficient is a ratio of the fuel consumption projected by the projecting unit and the fuel consumption estimated by the estimating unit.

19. The fuel-consumption projecting apparatus according to claim 18, wherein
the correcting unit regards the ratio of the projected fuel consumption before travel begins along the given interval and the estimated fuel consumption occurring during travel along the given interval as the correction coefficient.

20. The fuel-consumption projecting apparatus according to claim 18, wherein
the projecting unit, during travel along the given interval, substitutes into the first equation, the speed information acquired by the traveling-speed information acquiring unit and recalculates the fuel consumption,
the correcting unit regards the ratio of the fuel consumption recalculated by the projecting unit and the fuel consumption estimated by the estimating unit during travel along the given interval, as the correction coefficient.

21. The fuel-consumption projecting apparatus according to claim 14, wherein
the correcting unit corrects the first equation, if during travel along the given interval, road type of a road traveled by the vehicle does not change.

22. The fuel-consumption projecting apparatus according to claim 14, wherein the projecting unit uses equation (1) below as the first equation to project the fuel consumption
fc₁(x)=h·(m₁+m₂·x²+m₃·x³+m₄·x) (1)
Where,
fc₁: fuel consumption per unit time (cc/sec)
x: speed
$$( \frac{km}{h} )$$
h: correction coefficient
m₁ to m₄: constants

23. The fuel-consumption projecting apparatus according to claim 14, wherein the estimating unit uses equation (2) as the second equation to estimate the fuel consumption.
$$\begin{matrix}{fc}_{2} ( x ) = {k}_{1} + {k}_{2} \cdot x \cdot ( \frac{d x}{d t} + g \cdot sin θ ) + {k}_{3} \cdot G ( x ) \\ G ( x ) = {x}^{3} + {a}_{1} \cdot {x}^{2} + {a}_{2} \cdot x\end{matrix} \} \qquad ( 2 )$$
Where,
fc₂(x): fuel consumption per unit time (cc/sec)
x: speed
$$( \frac{km}{h} )$$
$$\frac{d x}{d t} \text{:} acceleration ( \frac{km}{h \cdot s} )$$
g: gravitational acceleration
$$( = 35.3 ( \frac{km}{h \cdot s} ) )$$
θ: slope of traveled road (radian)
k₁: coefficient based on fuel consumption when vehicle is stopped with engine running
$$( \frac{cc}{s} )$$
k₂: coefficient based on fuel consumption during acceleration
$$( \frac{cc \cdot {h}^{2}}{{km}^{2}} )$$
k₃: coefficient based on drag and rolling resistance
$$( \frac{cc \cdot {h}^{3}}{{km}^{3} \cdot s} )$$
a₁=−100 (km/h)
a₂=6000 (km/h²)

24. A fuel-consumption projecting method of projecting fuel consumption by a vehicle for a given interval, the fuel-consumption projecting method comprising:
projecting the fuel consumption before travel begins along the given interval, by using a first equation;
estimating the fuel consumption occurring during travel, the fuel consumption being estimated by using a second equation that sets vehicle acceleration occurring during travel as a variable; and
correcting the first equation, based on the fuel consumption projected at the projecting and the fuel consumption estimated at the estimating.

25. A non-transitory, computer-readable recording medium storing therein a fuel-consumption projecting program that causes a computer to execute:
projecting fuel consumption by a vehicle for a given interval, by using a first equation before travel begins along the given interval;
estimating the fuel consumption occurring during travel, the fuel consumption being estimated by using a second equation that sets vehicle acceleration occurring during travel as a variable; and
correcting the first equation, based on the fuel consumption projected at the projecting and the fuel consumption estimated at the estimating.
